(19) United States
(12) Patent Application Publication
(10) Pub. No.: US 2017/0142470 A1
(43) Pub. Date: May 18, 2017

(54) CAR ENTERTAINMENT CONTROL SYSTEM

(71) Applicant: Panasonic Automotive Systems Company of America, Division of Panasonic Corporation of North America, PEACHTREE CITY, GA (US)

(72) Inventors: YASUHIRO TSUCHIDA, SARATOGA, CA (US); TOSHIHIKO MORI, SUNNYVALE, CA (US); GERMANO LEICHSENRING, MOUNTAIN VIEW, CA (US)

(73) Assignee: Panasonic Automotive Systems Company of America, Division of Panasonic Corporation of North America

(21) Appl. No.: 15/348,142

(22) Filed: Nov. 10, 2016

Related U.S. Application Data
(60) Provisional application No. 62/254,648, filed on Nov. 12, 2015.

(51) Int. Cl. H04N 21/414; H04N 21/466; H04N 21/45; B60R 1/00; H04N 21/462

(52) U.S. Cl. CPC H04N 21/41422; B60R 1/00; H04N 21/462; H04N 21/4524; H04N 21/4668; B60R 2300/20; B60R 2300/207; B60R 2300/302; B60R 2300/80

(57) ABSTRACT

A vehicle includes a user interface having a plurality of components. A global positioning system determines a geographical location of the vehicle. An electronic processor is communicatively coupled to the user interface and the global positioning system. The electronic processor wirelessly receives data regarding road and traffic conditions from an external source. The electronic processor also determines which of the user interface components to use to present entertainment content to a driver of the vehicle based on the data regarding road and traffic conditions and the geographical location of the vehicle.

### CROSS-REFERENCED TO RELATED APPLICATIONS

This application claims benefit of U.S. Provisional Application No. 62/254,648filed on Nov. 12, 2015, which the disclosure of which is hereby incorporated by reference in its entirety for all purposes.

### FIELD OF THE INVENTION

The disclosure relates to the field of automotive entertainment systems, and, more particularly, to control apparatus for automotive entertainment systems.

### BACKGROUND OF THE INVENTION

A driver does not have much time to pay attention to entertainment content when driving, although the driver periodically has time periods in which he may safely pay attention to entertainment content, such as while he is waiting for a green traffic signal or while the car is parked. In the future, the driver may have more time in which he may safely pay attention to entertainment content due to the development of autonomous driving.

It is known to present entertainment content while the car is stopped, and to prohibit the presentation of entertainment content while the car is moving. However, the content is not presented dependent upon how long the car will be stopped, and the driver's attention is not directed to the driving task when his attention is called for. For example, the driver tends to keep watching a movie on a display screen in spite of the traffic signal turning green.

### SUMMARY

The present invention may calculate a safety level associated with driving, and assign resources and user interfaces in the car to entertainment content at a level that depends on the calculated safety level. When the calculated safety level drops, the driver's attention is directed to the driving task without occupying the driver's time with entertainment concerns and by providing the driver with effective instruction regarding the driving task. The invention may vary the level of car resources that are devoted to entertainment content depending on the current level of driving safety, and may effectively provide instructions on the user interface for the driver to timely return his attention to the driving task.

In one embodiment, the invention comprises a vehicle including a user interface having a plurality of components. A global positioning system determines a geographical location of the vehicle. An electronic processor is communicatively coupled to the user interface and the global positioning system. The electronic processor wirelessly receives data regarding road and traffic conditions from an external source. The electronic processor also determines which of the user interface components to use to present entertainment content to a driver of the vehicle based on the data regarding road and traffic conditions and the geographical location of the vehicle.

In another embodiment, the invention comprises a method of presenting entertainment content within a motor vehicle, including determining a geographical location of the vehicle. Data regarding road and traffic conditions is wirelessly received from an external source. A safety level associated with the vehicle is calculated based on data regarding road and traffic conditions and the geographical location of the vehicle. A length of time the vehicle is expected to be subject to the calculated safety level is estimated. One of a plurality of items of entertainment content is selected to present to a driver of the vehicle. The selecting is dependent upon a time duration of the one item of entertainment content and the estimated length of time the vehicle is expected to be at the calculated safety level. The selected one item of entertainment content is presented to the driver.

In yet another embodiment, the invention includes a method of presenting entertainment content within a motor vehicle, including determining a geographical location of the vehicle. Data regarding road and traffic conditions is wirelessly received from an external source. A portion of the user interface to use to present entertainment content to a driver of the vehicle is determined based on the data regarding road and traffic conditions and the geographical location of the vehicle.

### BRIEF DESCRIPTION OF THE DRAWINGS

A better understanding of the present invention will be had upon reference to the following description in conjunction with the accompanying drawings.

FIG. 1 is a block diagram of one embodiment of a vehicle entertainment control system of the present invention.

FIG. 2 is a flow chart of one embodiment of a method of the present invention for predicting safety levels.

FIG. 3 is a flow chart of one embodiment of a method of the present invention for adjusting the safety levels predicted in FIG. 2.

FIG. 4 is a schematic diagram illustrating example stop points and accident/traffic information associated with a trip made by a vehicle.

FIG. 5 is a schematic diagram illustrating example calculated safety levels associated with a trip made by a vehicle.

FIG. 6 is a flow chart of one embodiment of a method of the present invention for presenting entertainment content within a motor vehicle.

FIG. 7 is a flow chart of another embodiment of a method of the present invention for presenting entertainment content within a motor vehicle.

### DETAILED DESCRIPTION OF THE PREFERRED EMBODIMENTS

A safety level may be calculated for the route that the vehicle is traveling on. How long a period of time the driver is expected to be subject to this safety level may then be determined. These calculations may be based on the scheduled route, condition information, and driver information. The condition information may include the amount of traffic, accidents and pedestrians. The driver information may include the driver's schedule, which may indicate or predict whether the driver is in a hurry, and the driver's health information, which may indicate or predict whether the driver is tired or sleepy.

The entertainment content may be presented to the driver based on the safety level. For example, short advertisements for a main movie contents may be presented when the safety level is low, and the main movie may be presented with HMD/stereo when the safety level is high, such as during long highway trips when the cruise control is ON.

The safety level may be recalculated during driving, and the contents may be adjusted based on the recalculated safety level. The initial safety level is merely a predicted safety level, but the recalculated safety level is an actual safety level. The actual safety level may be a little different from the predicted safety level, depending upon the prediction accuracy. A safety level controller may utilize sensors and real-time cloud side information to calculate the current and very near future safety levels. For example, a vehicle-to-infrastructure (V2I) controller may receive next signal information and predict an accurate signal waiting time.

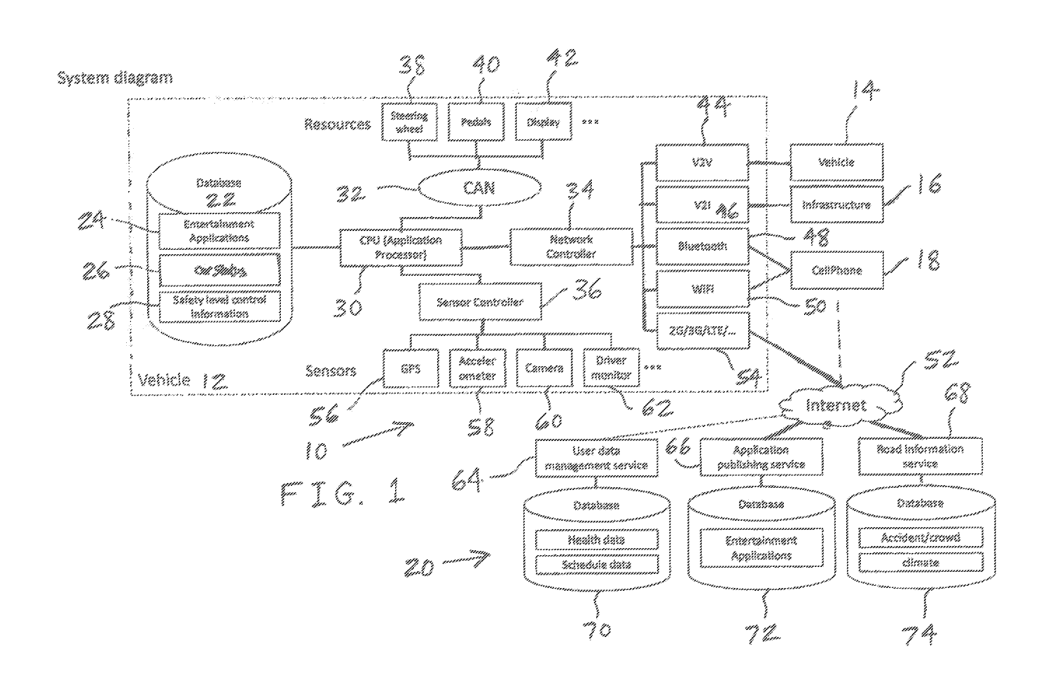

FIG. 1 illustrates one embodiment of a vehicle entertainment control system 10 of the present invention, including vehicles 12, 14, infrastructure 16, mobile communication device 18 and internet resources 20. Vehicle 12 includes a database 22 having entertainment applications 24, car status data 26, and safety level control information 28. Database 22 is connected to a CPU 30, functioning as an application processor, which is also connected to a controller area network (CAN) bus 32, a network controller 34, and a sensor controller 36. CAN 32 is further connected to resources including a steering wheel 38, pedals (e.g., gas and brake) 40 and a display screen 42, among others.

Network controller 34 is communicatively coupled to vehicle 14 through vehicle-to-vehicle module 44; to infrastructure 16 through vehicle-to-interface module 46; to cell phone 18 through Bluetooth module 48 or WiFi module 50; and to the Internet 52 through a mobile network 54 such as 2G, 3G, 4G, LTE, etc. Alternatively, network controller 34 may access Internet 52 through cell phone 18.

Sensor controller 36 is further connected to sensors, including GPS module 56, accelerometer 58, camera 60, and driver monitor 62, among others. Although a GPS module 56 is shown, other types of location-determining means such as beacons, vehicle to infrastructure (V2I), etc., may be used instead.

Through Internet 52, vehicle 12 may access resources 20, including a user data management service 64, an application publishing service 66, and a road information service 68. User data management service 64 may access a database 70 storing user health data and user schedule data. Application publishing service 66 may access a database 72 storing entertainment applications. Road information service 68 may access a database 74 storing accident/crowd information and climate information.

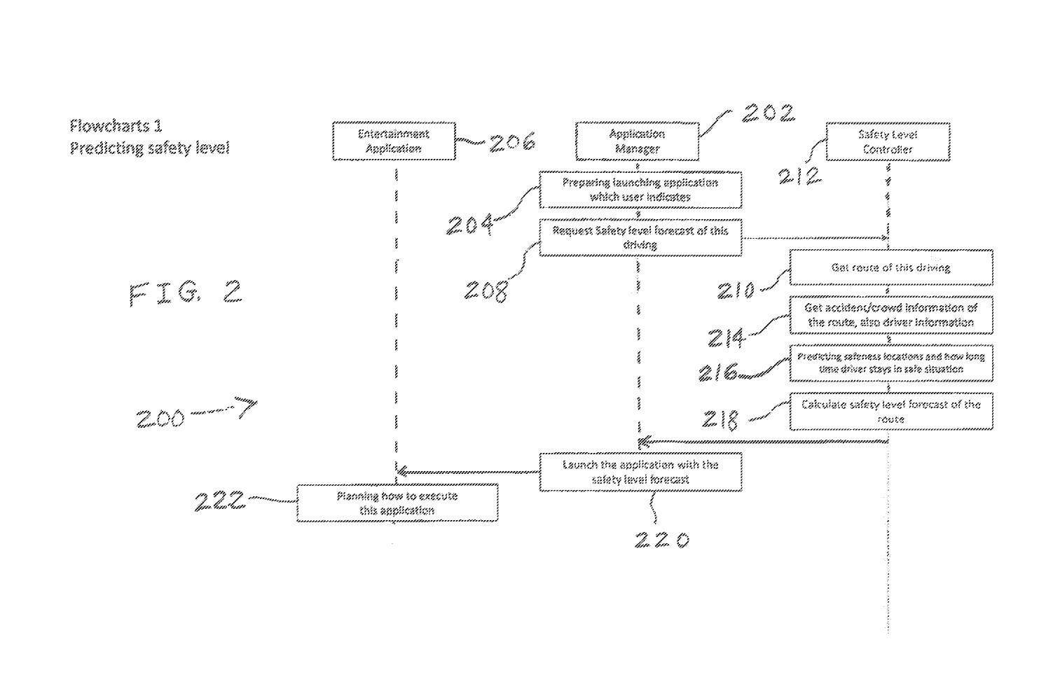

FIG. 2 illustrates one embodiment of a method 200 of the present invention for predicting safety levels. An entertainment application manager 202 prepares in step 204 to launch an entertainment application 206 selected by a user.

In step 208, application manager 202 requests a forecast of safety levels for a planned driving trip. In response, in step 210, a safety level controller 212 obtains the planned route of the vehicle, such as from a vehicle navigation system. Next, in step 214, safety level controller 212 obtains accident/traffic information, such as from database 74, and obtains driver information, such as from database 70.

In step 216, safety level controller 212 predicts which locations along the planned route will be safe (e.g., a low risk of an accident) and the lengths of the periods of time in which the vehicle will remain within the safe segments along the planned route. Safety level controller 212 also may use user data for calculating safety level. For example, if health data shows that the driver may be sleepy and/or schedule data shows that the driver may be in a hurry, then safety level controller 212 may decrease the safety level, and consequently no entertainment content may be shown to the driver.

In step 218, safety level controller 212 predicts or forecasts an alphanumeric safety level at each point along the planned route. More particularly, safety level controller 212 predicts at what points along the planned route that the safety level will change, and what values the safety level will change from and to at those points.

In step 220, the application manager 202 may launch entertainment application 206 with the safety level forecast being available to the application manager 202. Lastly, in step 222, it is planned how to execute entertainment system 206. For example, different levels of the entertainment system may be activated or presented to the driver depending upon the safety level that is current in effect, and how much of the driver's attention can be safely diverted to entertainment content.

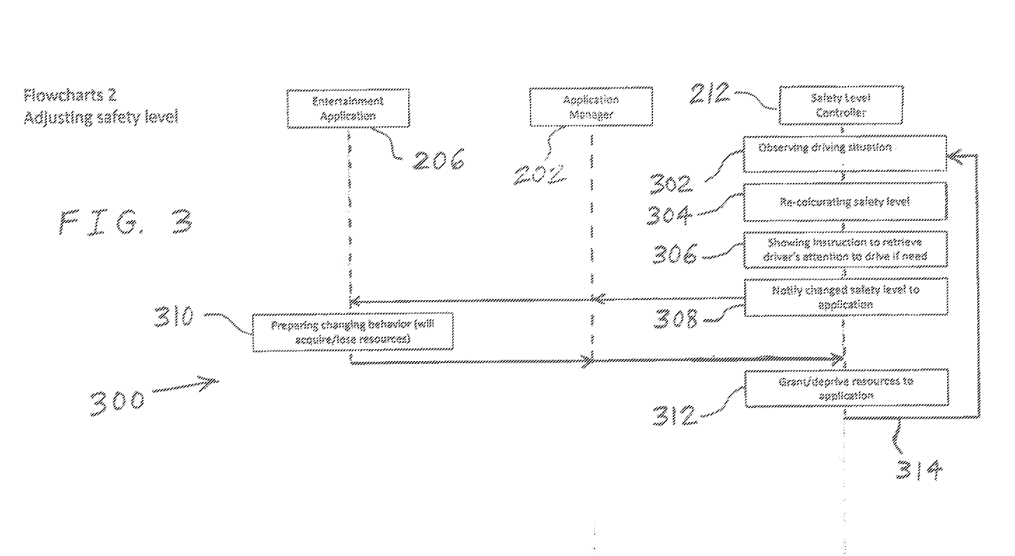

FIG. 3 illustrates one embodiment of a method 300 of the present invention for adjusting the safety levels predicted in method 200 of FIG. 2. Generally, in method 300 the safety levels predicted in method 200 may be adjusted during driving based on actual data collected while driving. In a first step 302, safety level controller 212 observes the driving situation and recalculates the safety levels (step 304) associated with the trip that the vehicle is currently taking.

In step 306, instructions are presented to bring the driver's attention back to the driving task, if needed. This may be called for in the event that the calculated safety level has fallen, possibly due to the vehicle reaching a high traffic area, and the driving task has become more difficult.

Next, in step 308, safety level controller 212 notifies entertainment application 206 of the changed state of the safety level. In step 310, entertainment application 206 prepares for changing operation due to the changed state of the safety level. For example, entertainment application 206 may prepare for how the entertainment content will be presented to the driver with the increased/decreased resources that will be available. In a final step 312, safety level controller 212 grants/deprives resources to entertainment application 206. For example, safety level controller 212 may make display screen 42 available if the safety level has risen, or may make display screen 42 unavailable if the safety level has fallen. Operation of method 300 then returns to step 302, as indicated at 314, and the above-described operation continues from step 302.

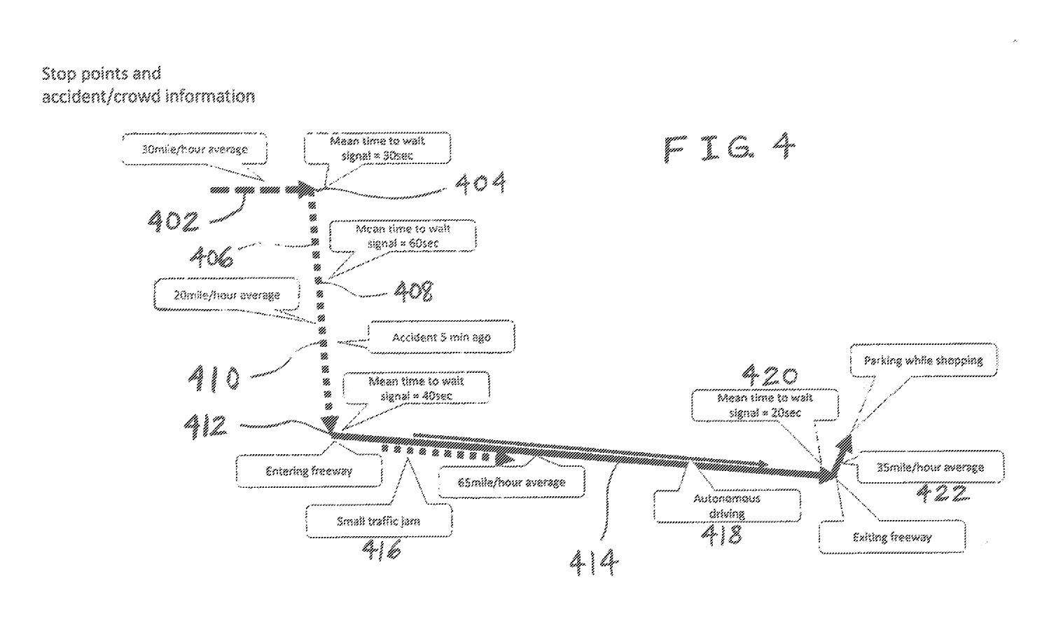

FIG. 4 illustrates one embodiment of an example trip made by a vehicle and associated stop points and accident/traffic information, all of which may be retrieved from database 74 via road information service 68. In a first trip segment 402, it is known that traffic averages 30 miles per hour. At stop point 404, which may the location of a traffic signal, it is known that the average time spent waiting at the traffic signal is 30 seconds.

In a second trip segment 406, it is known that traffic averages 20 miles per hour. At stop point 408, which may the location of a traffic signal within trip segment 406, it is known that the average time spent waiting at the traffic signal is 60 seconds. At point 410 it is known that there was a traffic accident five minutes ago, which is likely to slow down the vehicle as it travels through the accident zone. At stop point 412, which may the location of a traffic signal at the end of trip segment 406, where the vehicle enters the highway, it is known that the average time spent waiting at the traffic signal is 40 seconds.

In a third trip segment 414 on the highway, it is known that traffic averages 65 miles per hour. In a stretch 416, illustrated in FIG. 4 by a dotted arrow, it is known that there is a traffic jam, which is likely to slow down the vehicle as it travels through the traffic jam. In another stretch 418, illustrated in FIG. 4 by a solid arrow, it is known that conditions are conducive to autonomous driving, such as cruise control or completely automatic driving, which may free up the driver's attention for entertainment content. At stop point 420, which may the location of a traffic signal at the end of trip segment 414, where the vehicle exits the highway, it is known that the average time spent waiting at the traffic signal is 20 seconds.

In a fourth trip segment 422 which ends with parking while a passenger and/or driver of the vehicle is shopping, it is known that traffic averages 35 miles per hour. While the vehicle is parked, the driver may have a maximum of his attention directed to entertainment content.

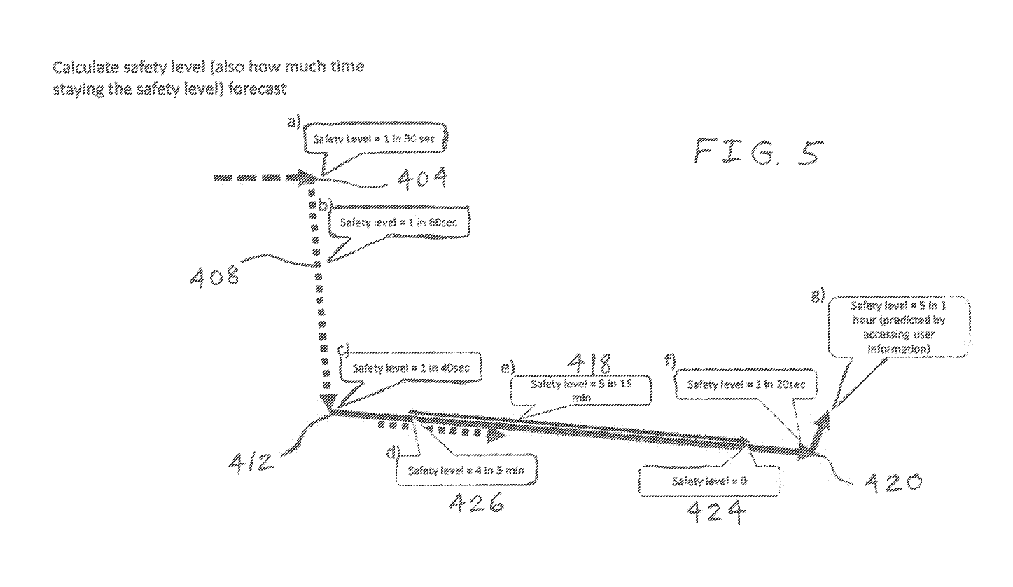

FIG. 5 illustrates the example trip of FIG. 4 and calculated safety levels associated with the trip. The lowest safety level of 0 (on a 0 to 5 scale), which calls for the most attention from the driver, occurs at point 424 where autonomous driving ends and the driver must again take up the driving task. The second lowest safety level of 1 occurs at the stop points 404, 408, 412 and 420, where the vehicle may be stopped at a traffic light. The second highest safety level of 4 occurs at point 426 where manual driving ends and autonomous driving begins. The highest safety level of 5 occurs during 15 minutes of autonomous driving 418 and during parking at the end of the trip, which is predicted to last one hour by accessing user information in database 70. Although safety levels 2 and 3 are not illustrated in FIG. 5, safety level 2 may apply when the vehicle is parked at the side of a busy road; and safety level 3 may apply when the vehicle is parked at the side of a road that is not busy.

The invention may formulate a plan for control of the entertainment system upon launching when the vehicle ignition is turned ON, the audio system is turned ON, and/or the vehicle navigation system has the plans for a trip to be made by the vehicle. For example, resources may be divided into components, wherein fewer or smaller components and resources may be utilized for presentation of entertainment content when the safety level is low and more of the driver's attention is needed for the driving task. Conversely, more or larger components and resources may be utilized for presentation of entertainment content when the safety level is high and less of the driver's attention is needed for the driving task. In one embodiment, only a corner of the display screen 42 is used as a window for presentation when the safety level is low, and the entire display screen 42 is used for presentation when the safety level is high. When the safety level is high, then stereo audio, and a head-mounted display (HMD) may be utilized for entertainment content presentation.

In one embodiment, inputs from the driver's operation of steering wheel 38 and pedals 40 are used in calculating or re-calculating the safety level. For example, a high degree of operation, or of continuity of operation, of steering wheel 38 and pedals 40 may indicate that the driving task is relatively complex, and thus the safety level is relatively low. These steering wheel 38 and pedals 40 may be used not only for driving and re-calculating the safety level, but also as input devices for entertainment applications, such as a video racing game, if the safety level is very high. In this case, the driver can use the steering wheel 38 and pedals 40 for controlling a virtual car in a race game application to achieve a very real racing experience in the racing game. Special instructions to retrieve the driver's attention to the driving task may be visible and/or audible when the safety level is about to be changed to a lower safety level, because the steering wheel 38 and pedals 40 may be used very differently in the racing game as compared to actual driving.

Entertainment application 206 may formulate a plan for presenting entertainment content during the trip shown in FIGS. 4-5, and based upon the calculated safety levels. For example, entertainment application 206 may plan to present news information according to the following schedule at locations a) through g) as marked in FIG. 5:
at a), headline of news 1, which the driver has the most interest in;
at b), headline of news 2, which the driver has the second most interest in;
at c), advertisement for documentary movie;
at d), overview of headline movie;
at e), introduction of main movie;
at f), headline of news 3, which the driver has the third most interest in; and
at g), main part of main movie.
   Thus, entertainment application 206 may present entertainment content of a time length matching the time length that the vehicle is in a same traffic situation and is at a same level of safety.

The actual level of safety may be different from the predicted level of safety due to actual traffic conditions when the vehicle passes through and/or arrives at a given area, and due to the actual operation of traffic signals. Safety level controller 212 collects environmental information from the sensors (camera 60, etc.), road information from road information service 68, and traffic signal information, which may be received from infrastructure 16 and/or database 74. Safety level controller 212 may then, based on such collected information, calculate or re-calculate safety levels in real time.

When the safety level changes from very high to very low, such as when exiting the highway and changing from autonomous driving mode to manual driving mode, presentation of the entertainment content may be suspended, and the driver may be instructed, via the user interface, to pay full attention to the driving task.

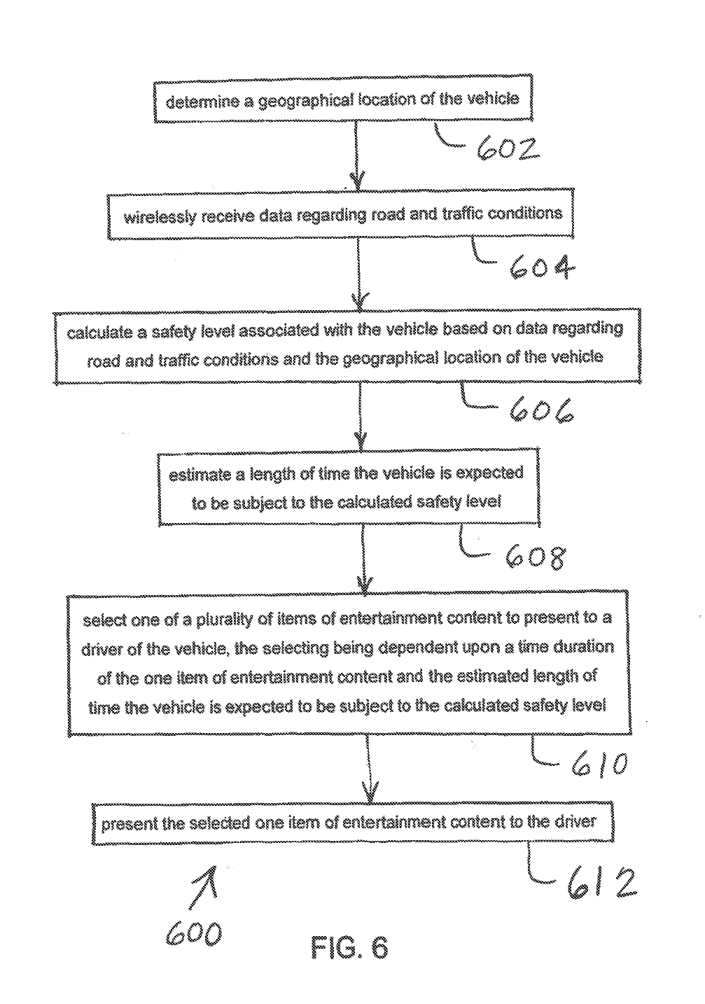

FIG. 6 illustrates one embodiment of a method 600 of the present invention for presenting entertainment content within a motor vehicle. In a first step 602, a geographical location of the vehicle is determined. For example, GPS module 56 may determine the geographical location of vehicle 12.

Next, in step 604, data regarding road and traffic conditions is wirelessly received. For example, safety level controller 212 may obtain accident/traffic information from database 74 via mobile network 54.

In a next step 606, a safety level associated with the vehicle is calculated based on data regarding road and traffic conditions and the geographical location of the vehicle. That is, safety level controller 212 may calculate a safety level based on accident/traffic information from database 74 and geographical coordinates received from GPS module 56.

In step 608, a length of time the vehicle is expected to be subject to the calculated safety level is estimated. For example, safety level controller 212 may predict the lengths of the periods of time in which the vehicle will remain within the safe segments along the planned route.

In a next step 610, one of a plurality of items of entertainment content is selected to present to a driver of the vehicle. The selecting is dependent upon a time duration of the one item of entertainment content and the estimated length of time the vehicle is expected to be subject to the calculated safety level. In a final step 612, the selected one item of entertainment content is presented to the driver. For example, entertainment application 206 may present entertainment content of a time length matching the time length that the vehicle is in a same traffic situation and is at a same level of safety.

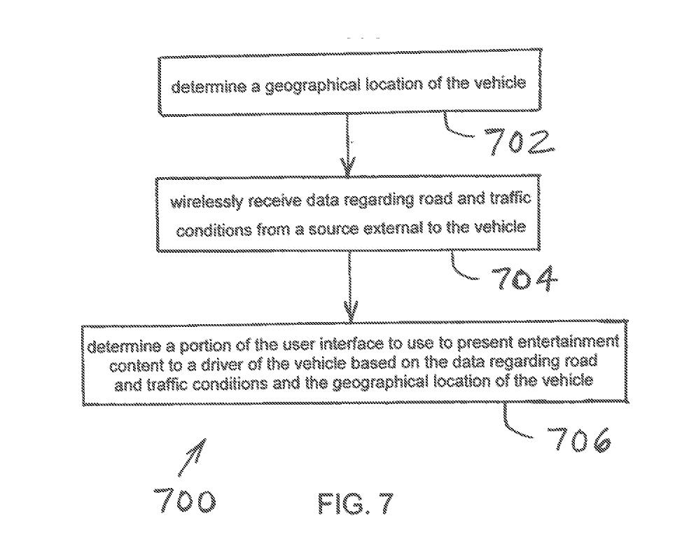

FIG. 7 illustrates another embodiment of a method 700 of the present invention for presenting entertainment content within a motor vehicle. In a first step 702, a geographical location of the vehicle is determined. For example, beacons or vehicle to infrastructure (V2I) may determine the geographical location of vehicle 12.

Next, in step 704, data regarding road and traffic conditions from a source external to the vehicle is wirelessly received. For example, safety level controller 212 may obtain accident/traffic information from database 74 via mobile network 54.

In a final step 706, a portion of the user interface to use to present entertainment content to a driver of the vehicle is determined based on the data regarding road and traffic conditions and the geographical location of the vehicle. For example, only a corner of the display screen 42 may be used as a window for presentation when the safety level is low, and the entire display screen 42 may be used for presentation when the safety level is high, wherein the safety level is calculated based on road and traffic conditions and the geographical location of the vehicle.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a user interface including a plurality of components;
location-determining means configured to determine a geographical location of the vehicle; and
an electronic processor communicatively coupled to the user interface and the location-determining means, the electronic processor being configured to:
wireles sly receive data regarding road and traffic conditions from an external source; and
determine which of the user interface components to use to present entertainment content to a driver of the vehicle based on the data regarding road and traffic conditions and the geographical location of the vehicle.

2. The vehicle of claim 1 wherein the processor is configured to determine which of a plurality of entertainment content items to present to a driver of the vehicle based on the data regarding road and traffic conditions and the geographical location of the vehicle.

3. The vehicle of claim 1, further comprising a navigation system including navigation data identifying geographical locations of a plurality of road segments to be driven on by the vehicle during a trip, the electronic processor being communicatively coupled to the navigation system, the road and traffic conditions being associated with the road segments to be driven on by the vehicle during the trip.

4. The vehicle of claim 1 wherein the processor is configured to compute a safety level and determine which of the user interface components to use to present entertainment content to the driver of the vehicle based on the safety level.

5. The vehicle of claim 4 further comprising a plurality of sensors configured to collect empirical traffic condition data, the processor is configured to recalculate the expected length of time the vehicle will be subject to a same said safety level, the recalculating being dependent upon the empirical traffic condition data.

6. The vehicle of claim 5 wherein the sensors comprise at least one of a steering wheel sensor, a gas pedal sensor, a brake pedal sensor, a global positioning system, an accelerometer, a camera, and a driver monitor.

7. The vehicle of claim 4 wherein the processor is configured to determine which of a plurality of entertainment content items to present to a driver of the vehicle based on respective time durations of the entertainment content items and an expected length of time the vehicle will be subject to a same said safety level.

8. The vehicle of claim 7 wherein the processor is configured to select one of the entertainment content items that has a time duration that matches the expected length of time the vehicle will be subject to the same said safety level.

9. The vehicle of claim 8 wherein the processor is configured to access schedule data associated with the driver, the schedule data including a time period when the vehicle is parked, the processor being configured to select one of the entertainment content items dependent upon the time period when the vehicle will be parked.

10. A method of presenting entertainment content within a motor vehicle, the method comprising:
determining a geographical location of the vehicle;
wirelessly receiving data regarding road and traffic conditions;
calculating a safety level associated with the vehicle based on data regarding road and traffic conditions and the geographical location of the vehicle;
estimating a length of time the vehicle is expected to be subject to the calculated safety level;
selecting one of a plurality of items of entertainment content to present to a driver of the vehicle, the selecting being dependent upon a time duration of the one item of entertainment content and the estimated length of time the vehicle is expected to be subject to the calculated safety level; and
presenting the selected one item of entertainment content to the driver.

11. The method of claim 10 wherein the selecting step comprises selecting one of the entertainment content items that has a time duration that matches the expected length of time the vehicle will be subject to the same said safety level.

12. The method of claim 11 further comprising accessing schedule data associated with the driver, the schedule data including a time period when the vehicle will be parked, the selecting step being dependent upon the time period when the vehicle will be parked.

13. The method of claim 10 further comprising:
using sensors within the vehicle to collect empirical traffic condition data;
recalculating the safety level associated with the vehicle based on the empirical traffic condition data and the geographical location of the vehicle; and
repeating the selecting and presenting steps based on the recalculated safety level.

14. The method of claim 13 further comprising, in response to the recalculated safety level being lower than an immediately previously calculated safety level, suggesting to the driver that he turn his attention to a driving task.

15. A method of presenting entertainment content within a motor vehicle, the method comprising:
determining a geographical location of the vehicle;
wirelessly receiving data regarding road and traffic conditions from a source external to the vehicle; and
determining a portion of the user interface to use to present entertainment content to a driver of the vehicle based on the data regarding road and traffic conditions and the geographical location of the vehicle.

16. The method of claim 15 wherein the user interface comprises a display screen, and the portion comprises a corner of the display screen.

17. The method of claim 15 wherein the user interface comprises a plurality of loudspeakers, and the portion comprises a subset of the loudspeakers.

18. The method of claim 15 further comprising computing a safety level, the determining step being dependent upon on the safety level.

19. The method of claim 18 further comprising:
collecting empirical traffic condition data; and
calculating an expected length of time the vehicle will be subject to a same said safety level, the calculating being dependent upon the empirical traffic condition data, the determining step being dependent upon on the expected length of time the vehicle will be subject to a same said safety level.

20. The method of claim 19 further comprising determining which of a plurality of entertainment content items to present to a driver of the vehicle based on respective time durations of the entertainment content items and the expected length of time the vehicle will be subject to a same said safety level.
